(19) United States
(12) Patent Application Publication
(10) Pub. No.: US 2024/0377966 A1
(43) Pub. Date: Nov. 14, 2024

(54) MECHANISM FOR PREVENTING UNINTENTIONAL SECURE ERASE OR SANITIZE OPERATIONS ON A STORAGE DEVICE

(71) Applicant: New Concepts Development Corporation, Woodstock, IL (US)

(72) Inventor: Farshid Tabrizi, San Jose, CA (US)

(21) Appl. No.: 18/659,055

(22) Filed: May 9, 2024

Related U.S. Application Data
(60) Provisional application No. 63/465,847, filed on May 11, 2023.

(51) Int. Cl. G06F 3/06

(52) U.S. Cl. CPC G06F 3/0619; G06F 3/0652; G06F 3/0673

(57) ABSTRACT

An integrated hardware and software system detects and prevents accidental secure erase on a storage device. It includes a detection engine using a unique identifier on the storage device to identify if the information stored on the storage unit has been previously copied before allowing performance of secure erase on such storage device. When it is detected that the data has not been copied and verified, the system automatically blocks the secure erase function if enabled in the software application component. The system keeps track of the storage device history to be aware that the last function on the storage device, based on its unique identifier, was a secure erase so that the next time it detects data on the storage device, it is aware that this data is new data; not copied and checksum verified while triggering the disabling of the secure erase software component functionality.

### CROSS REFERENCE TO RELATED APPLICATIONS

This application claims the benefit of U.S. Provisional Application No. 63/465,847 filed on May 11, 2023. The entire contents of this application is incorporated herein by reference in its entirety.

### BACKGROUND

The present invention relates to an integrated hardware and software solution that reduces or eliminates the chance of accidental or unintentional erasure of content on a storage device when used with a software application that performs data copy or ingest and verification using a checksum mechanism before securely erasing or sanitizing the storage device.

In general, a checksum is a string or sequence of numbers and letters that act as a “fingerprint” for a file against which later comparisons can be made such as to detect errors in the data that has been transferred or copied. It is sometimes defined as a digit representing the sum of digits in a piece of stored or transmitted digital data, against which later comparisons can be made to detect errors.

Data ingest software applications are a key part of the data capture process used by photographers, filmmakers, and others to ensure that content on the original storage media or device is identical to the copy of the data on a destination storage device through checksum verification. Comparatively, there are other software applications that will execute a secure erase or sanitize a storage device to permanently remove the content from the device, bringing it as close as possible to its out-of-factory state. Using the other applications, a user could accidently erase the data before the data was copied/ingest and verified on such storage device.

Various alternate approaches have been attempted to integrate the data copy/ingest software application with the software applications that perform the secure erase and sanitize functionality. However, there are no currently available methods to prevent accidental or unintentional erasure of the data before the data is copied and verified through such integration.

Therefore, there is a need for a novel type of system that prevents accidental or unintentional erasure of data, comprising a software layer or functionality integrated within the data copy/ingest application, the secure erase or sanitize application and the physical storage hardware that contains the original content, its history and the last time it was securely erased or sanitized, so that when there is new data on the device, it automatically disables the erasure functionality before the data has been copied/ingest and verified via a checksum mechanism.

### SUMMARY

Disclosed is a hardware and software system and method for detecting and preventing an accidental or unintentional secure erase or sanitize operation on a storage device.

The system includes a detection engine or module to identify if the content of a storage device is copied and verified to an alternate storage location before enabling the storage device's content to be permanently erased through secure erase or sanitize.

Additionally, in a preferred embodiment, the system keeps track of each storage device to know its history and to identify if the data on the storage device is new or if the data has been properly copied such that the device can be securely erased or sanitized.

In an embodiment of the system described herein, the system will also provide flexibility for overriding the system, such as by user override, so that the user can proceed with securely erasing or sanitizing the device even though new or uncopied data is present in the device.

### BRIEF DESCRIPTION OF THE DRAWINGS

The present disclosure will be better understood by reading the written description with reference to the accompanying drawing figure in which like reference numerals denote similar structure and refer to like elements throughout in which:

FIG. 1 illustrates an exemplary system or mechanism for preventing secure erase operations on a storage device before data is copied and verified.

### DETAILED DESCRIPTION

In accordance with a preferred embodiment for preventing unintentional secure erase or sanitize operations on a storage device of the present invention, an integrated secure erase capability is provided for a storage device. In particular, the combined hardware and software system for detecting and preventing the accidental erasure of data on a storage device before its content has been fully copied and verified on another storage device provide an effective and efficient solution for identifying and stopping an unintentional data loss event.

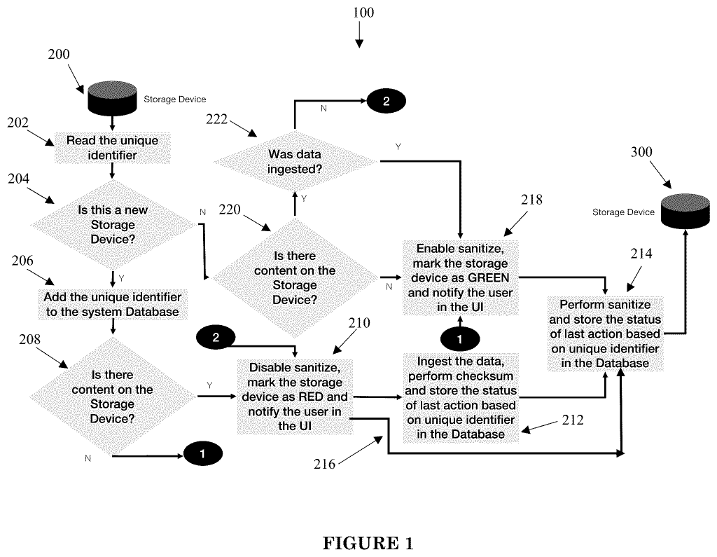

FIG. 1 illustrates an exemplary embodiment of the system and mechanism of the present invention. FIG. 1 illustrates a system 100 for detecting and preventing the accidental erasure of data on a storage device 200 before its content has been fully copied and verified on another storage device. The functionalities or operations of the embodiments presented below are intended to be illustrative. In some embodiments, the system may be accomplished with one or more additional functionalities or operations not described, and/or without one or more of the functionalities or operations discussed. Additionally, the order in which the functionalities or operations of system 100 are illustrated in FIG. 1 and described below is not intended to be limiting.

Referring to FIG. 1, the system 100 comprises a detection module in step 202 which leverages an identifier such as a unique identifier (UUID) on the storage device 200 to identify its history by reading the unique identifier. The detection module further comprises step 204 which determines whether the storage device is a new device being introduced into the integrated hardware and software system, or a device that has been used under the system before. If it is a new device, the system in step 206 will record its unique identifier in the software application.

In an embodiment of the system, for each installation of the application either in standalone or shared by multiple users in a shared environment, the application will record the UUID of each device in its internal database. Once a storage device is inserted, the UUID of the device will be checked against the current database. If UUID is not found in the database, then the application will treat this device as new and add its UUID to its database. The UUID will be recorded in the internal database of the software application. In a preferred embodiment, the UUID of each device will be in the form of ASCII alphanumeric characters. This information can also be shared, exported and read back on other instances of the application. If the UUID is already in the database, then the application identifies the device as a previously detected device, or a device that has been used under the system before.

As illustrated in FIG. 1, the system also comprises a blocking module which prevents a secure erase or sanitize to be performed on a storage device. In step 208, the system checks to see if there is any data or content on the device 200 that has been detected as a new device. If the device does contain data, in step 210, the secure erase or sanitize operation is disabled until the data has been copied and/or verified through the software's checksum algorithm. In addition, the system also comprises an alert module which will notify the user of the status through visual cues, such as marking the device as hot via a visual tag, highlighted in the user interface (UI) via an indicator color (such as red) for better visual feedback to the user that there is new and/or uncopied data on the storage device. The user may then proceed to step 212 to have the system ingest the data, perform checksum verification, and/or store the status of the last action based on the unique identifier in the database. After checksum verification is performed, the system in step 214 then proceeds to the sanitize function, and/or also store the status of the last action based on the unique identifier in the database. After the sanitize function is performed, the secure erase system is complete resulting in a sanitized storage device 300.

In other embodiments of this system, the user, in step 216, will have the ability to override the disabled secure erase or sanitize operation after a warning to allow the user to securely erase or sanitize its content, such as in instances when the data on the device is not important to, or no longer needed by, the user.

As illustrated in FIG. 1, in step 218, upon the erasure of the data via the software component, the storage device status and its visual tag within the UI will turn to an indicator color (such as green) informing the user that the device can now be securely erased and sanitized to an out-of-factory state. The device is then sanitized as in step 214.

If the storage device 100 upon its connection to the system is detected through its unique identifier as a device that has been used with the system before, in a preferred embodiment, the system first checks and identifies the last operation that was performed on the device. This identification can be done such as through a tag tied to the unique identifier in the database to check if the last operation was sanitize or not. The tag for sanitize can be a binary number. If, for example, it is set to “1,” this means that the storage device was sanitized the last time it went through the system.

As noted above, the system detects if the storage device 100 has any content stored on it or if the content is new compared to previous detection of the storage device. As illustrated in FIG. 1, if the storage device 100 was previously securely erased and/or sanitized, then the system in step 220 will check to see if the storage device now contains any new data. If it does, the system will disable the secure erase and sanitize functionality and, in an exemplary embodiment, will tag the device as changed in the user interface for better visual feedback to the user that there is some new content on the storage device compared to its last status condition when it left or was removed from the system. As shown in FIG. 1, the system in step 222 will then determine whether the data was already copied (or ingested), and/or checksum verified. If the data was previously copied or ingested, the system will automatically enable sanitize, and the storage device will be marked as green to notify the user in the user interface, as noted in step 218. The system will then allow the user to proceed with the sanitize function, and will also store the status of the last action based on the unique identifier in the database, as in step 214. If the data was not previously copied or ingested, the system will disable the secure erase and sanitize functionality, and will mark the storage device with an indicator such as red and notify the user in the user interface as noted in step 210. If no data is detected, the system will tag the storage device with a visual indicator (such as in green) on its user interface and will allow the storage device to be safely and securely erased or sanitized, as in steps 218 and 214.

As illustrated in FIG. 1 and described above, in embodiments of the system, the system may also comprise a module to keep track of historical activities and the last activity on the storage device through its unique identifier. After checksum verification is performed, the status of this action is stored in a database using a unique identifier. Additionally, after sanitize is performed, the status of this action is stored in a database using a unique identifier. Thus, the system may also comprise a detection system through a unique identifier on the storage device to identify if the content and the data stored on the storage unit has been previously copied and checksum verified.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

While the invention has been disclosed in connection with preferred embodiments shown and described in detail, their modifications and improvements thereon will become readily apparent to those skilled in the art. The features of the present invention may be enabled using some or all of the described elements without departing from the spirit and scope of the present invention.

1. An integrated hardware and software system for preventing an accidental secure erase or sanitize on a storage device, comprising:
a detection module configured to identify if a storage device is being introduced to the system for the first time or has been introduced previously, wherein said detection module is also configured to detect whether said storage device contains data, and whether said data has previously been copied; and,
a blocking module configured to prevent a secure erase function to be performed on said storage device, if said data on said storage device has not previously been copied.

2. The system of claim 1, further comprising an alert module configured to notify a user that said data on the storage device has not previously been copied.

3. The system of claim 1, wherein said detection module identifies whether said data has previously been copied, through a unique identifier on said storage device.

4. The system of claim 1, further comprising an override functionality wherein said system permits said secure erase function even though said data on said storage device has not previously been copied.

5. The system of claim 1, wherein said detection module identifies if said storage device is being introduced to the system for the first time or has been introduced previously, through a unique identifier on said storage device.

6. The system of claim 1, further comprising a tracking module to keep track of historical activities on said storage device comprising the last activity on said storage device.

7. The system of claim 1, wherein said detection module is also configured to detect whether checksum verification has previously been performed on said data.

8. The system of claim 2, wherein said notification is through a user interface via a visual indicator.

9. An integrated hardware and software mechanism for preventing an accidental secure erase or sanitize on a storage device, comprising the steps of:
providing a detection module configured to determine whether said storage device is a new device, or a device that has been used before through a unique identifier (UUID);
providing a secure erase operation functionality within an application within said mechanism;
determining whether said storage device contains data, wherein if said storage device contains data, disabling said secure erase functionality within said application after said data is detected;
performing ingestion on said data;
performing checksum verification on said data; and,
performing sanitize function on said storage device.

10. The mechanism of claim 9, further comprising the steps of:
providing a database; and,
storing in said database status of last action performed on said storage device after said last action is performed.

11. The mechanism of claim 9, further comprising the step of overriding said disabling of said secure erase functionality, after said step of determining whether said storage device contains data.

12. The mechanism of claim 9, further comprising the step of: upon performance of said sanitize function on said storage device, informing a user via a visual tag within a user interface.

13. The mechanism of claim 9, further comprising the steps of:
determining if said data was previously ingested; and,
enabling said sanitize function on said storage device.

14. The mechanism of claim 9, further comprising the steps of providing a detection system to identify if said data on said storage device has been previously copied and checksum verified.

15. The mechanism of claim 10, wherein status of said last action is stored in said database using a unique identifier.
